(19) United States
(12) Patent Application Publication
(10) Pub. No.: US 2024/0183045 A1
(43) Pub. Date: Jun. 6, 2024

(54) ELECTROLYSIS DEVICE

(71) Applicant: Siemens Energy Global GmbH & Co. KG, München (DE)

(72) Inventors: Marc Hanebuth, Nürnberg (DE); Stephan Rückert, Erlangen (DE); Peter Utz, Nürnberg (DE)

(21) Appl. No.: 18/552,686

(22) PCT Filed: Apr. 7, 2022
(86) PCT No.: PCT/EP2022/059205

§ 371 Date: Sep. 27, 2023

(30) Foreign Application Priority Data
Apr. 14, 2021 (EP) 21168348.7

(51) Int. Cl. C25B 9/77; C25B 15/08

(52) U.S. Cl. CPC C25B 9/77; C25B 15/08

(57) ABSTRACT

The invention relates to an electrolysis device including a plurality of electrolysis cells which are electrically connected in series and which are arranged at least partly successively in a stacking direction in a cell stack, where the series connection can be electrically coupled to an electrical energy source. A cell supply unit for supplying at least one operating medium to the electrolysis cells in normal operation and supply lines connected to the cell supply unit and to the cell stack, where a material of the supply lines include metal. The supply lines are connected to a first end of the cell stack so that the first end of the cell stack is electrically coupled to the cell supply unit, where the first end of the cell stack can be coupled to a negative electrical potential of the electrical energy source.

### BACKGROUND

The invention relates to an electrolysis device.

Electrolysis cells, which are used to convert chemical substances into other chemical substances under the action of electricity, are extensively known in the prior art. In general, an electric current is used to bring about a chemical reaction, that is to say substance conversion. This is called electrolysis. A known and widely used form of electrolysis is water electrolysis. In water electrolysis, water is decomposed into its constituents, namely hydrogen and oxygen, using the electric current. In principle, however, other substances may also be subjected to electrolysis, for example carbon dioxide or the like.

These are typically fluid substances that can be fed via corresponding supply conduits to the electrolysis cells in which the actual electrolysis is conducted. The electrolysis products are often likewise in fluid form and are removed from the electrolysis cells via further supply conduits. The supply conduits are generally connected to a cell supply unit that serves to supply the electrolysis cells for operation as intended with the respective substances/at least one operating material. “Supply” here thus means not only feeding of the operating material or of the substance to be electrolyzed but also removal of the respective electrolysis product.

The provision of hydrogen in particular proves to be of industrial interest, especially since hydrogen can be a widely usable energy carrier. Hydrogen can be provided by an electrolysis device, also called an electrolyzer, using renewably generated electrical energy. One possibility for producing hydrogen consists in using an electrolysis device having electrolysis cells that are based on proton exchange membranes (PEMs).

### SUMMARY

In accordance with an embodiment, an electrolysis device is provided. The electrolysis device includes a plurality of electrolysis cells that are electrically connected in series and are arranged in a cell stack successively at least partly in a stack direction, where the series connection is electrically couplable to an electrical energy source. The electrolysis device also includes a cell supply unit for supplying the electrolysis cells with at least one operating material and supply conduits connected to the cell supply unit and to the cell stack. A material of the supply conduits includes metal, characterized in that the supply conduits are connected exclusively at a first end of the cell stack such that the first end of the cell stack is electrically coupled to the cell supply unit, wherein the first end of the cell stack is couplable to a negative electric potential of the electrical energy source.

### BRIEF DESCRIPTION OF THE DRAWINGS

FIG. 1 shows a schematic block diagram of an electrolysis device for the electrolysis of water;

FIG. 2 shows a schematic sectional illustration of a supply conduit of the electrolysis device according to FIG. 1 in the region of an insulating section;

FIG. 3 shows a schematic block diagram like FIG. 1 of a further electrolysis device for the electrolysis of water, in which supply conduits are connected only at a first end of a cell stack according to a first configuration; and

FIG. 4 shows a schematic illustration like FIG. 3 for a second configuration of the electrolysis device.

### DETAILED DESCRIPTION

Generic electrolysis devices generally have a plurality of electrolysis cells that are typically electrically connected in series. The series connection that is formed thereby is electrically coupled to an electrical energy source that provides a suitable electric voltage so that the intended process of electrochemical substance conversion can be implemented by means of the electrolysis cells.

The electrolysis cells are additionally arranged successively in a stack direction so that they form a cell stack. The stacked arrangement makes it possible for the successively arranged electrolysis cells to be directly electrically contacted, meaning that separate electrical connections of the electrolysis cell can be extensively reduced.

Further provided within the cell stack is a supply conduit system having cell connection conduits (manifold) or a supply structure that serves inter alia to feed the at least one operating material to the electrolysis cells and remove it. The operating material may for example include the fed fluid, for example water, and/or the reaction product, for example hydrogen and oxygen. The cell stack is generally operated with a certain electrolysis power such that an electric current is as small as possible but an electric voltage is as great as possible. This is achieved by a suitable stacking of the electrolysis cells in the cell stack. As a result, electric voltages at the respective electrolysis cells in the cell stack can add up to the cell stack voltage, while the electrolysis cells connected in series in this way can be operated with an essentially equal current.

The electrolysis power is provided by the energy source, which for this purpose is connectable to respective opposite ends of the cell stack. A multiplicity of electrolysis cells can be arranged in a cell stack, for example more than 100 electrolysis cells, especially several hundred electrolysis cells, but not more than around 400 electrolysis cells. When electrolyzing water to hydrogen and oxygen, an electric voltage at a respective one of the electrolysis cells is around 1.5 V to 2.5 V. The electric voltage at the cell stack correspondingly results from this, meaning that the electric voltage at the cell stack often exceeds 100 V, and may even be several hundred volts.

In addition to the cell stack, the electrolysis device includes further components, such as for example pumps, heat exchangers, separating vessels, which are required for the operation as intended of the electrolysis device or electrolysis cells. These components are in the present case subsumed under the cell supply unit for supplying the electrolysis cells for operation as intended with at least one operating material.

The cell supply unit is connected to the electrolysis cells arranged successively in a stack direction via supply conduits that are connected at opposite ends of the successively arranged electrolysis cells. The supply conduits are generally formed from a material such as metal or the like.

A correspondingly high electric voltage arises between the ends of the cell stack or of the successively arranged electrolysis cells. For the supply conduits, which are generally formed from a metal, it is therefore necessary for them to have respective electrical insulating sections that serve to avoid an electrically well-conducting connection between the ends of the successively arranged electrolysis cells and hence between the electrical connections of the electrical energy source.

With respect to a electrolysis device, the supply conduits are connected exclusively at a first end of the cell stack such that the first end of the cell stack is electrically coupled to the cell supply unit, wherein the first end of the cell stack is electrically couplable to a negative electric potential of the electrical energy source.

In exemplary embodiments, the construction of the electrolysis device makes it possible for the supply conduits to only need to be arranged or connected at the first end of the cell stack. As a result, the supply conduits can be kept essentially at an equal electric potential, which corresponds to an electric reference potential of the cell supply unit, meaning that insulating sections in supply conduits can be largely avoided. The supply conduits can thus provide an electrical coupling or electrical connection of the first end of the cell stack to the cell supply unit. One of the two electric potentials of the electrical energy source is preferably also connectable at the first end of the cell stack. The electric reference potential of the cell supply unit can for example be an electrical ground of the cell supply unit or the like. This can also largely avoid the corrosion elucidated at the outset, if not even completely prevent it. In one embodiment, the second end of the cell stack is configured without supply conduits. Only the other electric potential of the electrical energy source needs to be connectable at the second end of the cell stack. Harmful corrosion-promoting electric potential differences in the region of the supply conduits can thus largely be avoided, in particular also since the supply conduits themselves are electrically conductive.

In one embodiment, the negative electric potential of the electrical energy source is electrically connected to the first end of the cell stack and the positive electric potential of the electrical energy source is electrically connected to the second end of the cell stack. The potential difference between the first and the second electric potential of the electrical energy source determines an electric voltage that is applied to the cell stack. On account of the electrically series-connected electrolysis cells, an electric partial voltage is present at each of the electrolysis cells.

In one embodiment, the corrosive effect can be reduced since the conditions that are detrimental to the corrosive effect can be reduced. Due to the electric potential difference on the insulating sections of the supply conduits, in the prior art an electric current can arise in the fluid conveyed by the respective supply conduit, especially when it is water. Consequently, there may be release of hydrogen and hydroxide ions. The invention makes it possible to reduce or even completely avoid the conditions relevant for the corrosive effect, namely in particular the hydroxide ions. They are therefore no longer available for the undesired corrosive effect. The invention thus makes it possible overall to reduce or even completely avoid the undesired corrosion action.

The electrolysis cells may for example be arranged successively in a single cell stack. In one embodiment, the electrolysis cells are electrically connected in series within the cell stack. The opposite ends of the cell stack, and specifically the first and the second end, are connectable to the respective electric potentials of the electrical energy source. They can for example be directly connected to the electrical energy source. In another embodiment, however, they are connected to the electrical energy source via a control unit, so that the functioning of the electrolysis cells can be set as required.

The electrical energy source can for example be any voltage source or else current source that is able to provide sufficient power for conducting the electrolysis by way of the electrolysis cells. An electrolysis power can be determined for a specific surface current density depending on the dimensions of the respective electrolysis cell, in particular the electrolytically active regions thereof.

The supply conduits have a through-opening having a suitable internal diameter or internal cross section for allowing the respective operating material to be conducted into the cells in as loss-free a manner as possible and/or to be removed from the respective electrolysis cells in as loss-free a manner as possible.

It is in principle sufficient for a single one of the supply conduits to be completely electrically conductive. Some or all other of the supply conduits then do not need to provide an electrical conductivity between their respective ends. These supply conduits can have respective electrical insulating sections, so that their opposite ends are electrically insulated from one another. The electrical insulating sections of these supply conduits can for example be formed from a suitable material that can be mechanically firmly connected to the respective supply conduit. This may for example involve an annular section arranged at a respective end of a respective supply conduit. The insulating section can of course moreover also be integrated into the supply conduit so that the supply conduit has two mutually electrically insulated supply conduit sections that are separated from one another by the insulating section. These thus-formed units are connected to one another in fluid-tight fashion, with an essentially constant internal cross section being provided for the respective operating material.

The material provided for the electrical insulating section may for example be a plastic, a ceramic, but also a metal oxide such as for example titanium dioxide, aluminum oxide and/or the like. Furthermore, provision may also be made of a composite material which can for example be formed from a plastic that may for example be fiber reinforced. Of course, provision may also be made of virtually any combinations of these that are selected such that a chemical reaction with the operating material to be respectively conveyed is essentially avoided.

The material of the supply conduit includes at least metal. The metal can for example be a steel, especially a stainless steel. Of course, another metal, for example titanium or the like, may furthermore also be used. Corresponding metal alloys can of course also be provided.

In one embodiment, the cell stack has cell connection conduits, also called manifold, for fluidically coupling the electrolysis cells to the supply conduits connected at the first end. As a result, the supply conduits can be fluidically coupled to the electrolysis cells. The cell connection conduits can be provided, in the manner of a cell stack supply structure, by the cell stack itself. There is therefore in particular no need to provide any separate supply structure in the region of the cell stack for connecting the electrolysis cells to the supply conduits. This also facilitates the connection of the supply conduits to the cell stack. The cell connection conduits are integrated into the cell stack. By way of example, there may be provision that each of the electrolysis cells provides a respective section of a respective one of the cell connection conduits. The stacking of the electrolysis cells makes it possible then for the respective sections to be connected fluidically to one another and sealed such that the respective cell connection conduits can be formed.

In one embodiment, the cell connection conduits each have a through-opening that is configured such that a pressure drop on the cell connection conduits allows uniform operation as intended of the electrolysis cells. In one embodiment, the pressure drop is as small as possible, especially negligibly small, in operation as intended of the electrolysis device. As a result, it can be achieved that the electrolysis cells in operation as intended can be stressed essentially equally even though the supply is effected by the supply conduits connected exclusively at the first end of the cell stack. By way of example, for this purpose an internal diameter of the cell connection conduits that is selected to be correspondingly large may be provided so that for example a pressure drop over a respective conduit length of the respective cell connection conduits is small compared to an operating pressure at the electrolysis cells. However, there may also be provision that the internal diameter of the cell connection conduits depends on a respective distance between a position of the respective cell connection conduits and the first end of the cell stack. By way of example, the internal diameter can become at least in part smaller as the distance from the first end of the cell stack increases.

In order to further improve the effect of the invention, it is proposed that the through-opening has an inner surface that has been coated with an anodically stable layer. As a result of the anodically stable layer it can be achieved that any hydroxide ions present essentially fail to find any reaction partners, meaning that the effect of corrosion can be reduced further. The anodically stable layer can for example include a plastic, a metal oxide such as for example titanium dioxide or the like.

According to a further development, it is proposed that the cell connection conduits are at least partially non-metallic. The cell connection conduits can for example include a plastic, a ceramic material or the like. This makes it possible to avoid the possibility of metal ions being provided that inter alia can lead to the undesired corrosive effect or else to the aforementioned contaminations.

It is further proposed that the cell connection conduits are at least partially electrically insulated. As a result, in particular in a construction in the manner of the cell stack, an electrical insulation of the successively arranged/stacked electrolysis cells can be achieved. No separate electrical insulating measures need therefore be provided for the supply of the electrolysis cells. The cell connection conduits can for example have a layer of a suitable material on an inner side of their through-openings. This layer can include a coating formed from an electrically non-conductive plastic, an electrically non-conducting ceramic material or the like.

It is moreover proposed that the supply conduits are configured at least partially without insulating sections. As a result, the supply conduits can firstly be formed essentially homogeneously from a single material, for example metal, especially stainless steel, and secondly a good electrical coupling between the first end of the cell stack and the cell supply unit can be achieved. In one embodiment, the supply conduits are equally formed at least in relation to the material. They may, inter alia, also have the same internal cross section.

It is further proposed that the cell supply unit is at least indirectly electrically grounded. The cell supply unit with the supply conduits electrically coupled thereto can be connected to a predetermined reference potential by the grounding. As a result of this, the negative potential of the electrical energy source, which is electrically coupled to the cell supply unit via the supply conduits, can at the same time also likewise be indirectly at least grounded. In distinction from the prior art, therefore, the cell stack is at a defined electric potential with respect to the ground potential and is thus no longer subjected to a floating potential. As a result of this, an electric potential difference or electric voltage can thus be largely avoided in the region of the supply conduits. This makes it possible to further improve the functional reliability of the invention.

It is furthermore proposed that the grounding has a sacrificial anode and/or a voltage source, by means of which an electric potential that is negative with respect to the ground potential is applicable to the cell supply unit. This can achieve a “cathodic corrosion protection”. If a voltage source is used, the negative electric potential of the voltage source can be electrically connected to the cell supply unit and to the supply conduits connected thereto. The negative electric potential of the voltage source is likewise correspondingly grounded. For good functioning of the thus-realized corrosion protection, there can be provision that the voltage source provides an electric voltage in a range from around−2 V to around zero volts in relation to the ground potential. In one embodiment, the electric voltage is chosen within a range from around−1 V to around−0.8 V. A corrosion of for example stainless steel can be avoided with an electric voltage chosen within this range, even under maritime conditions, especially in offshore applications. In particular, an external corrosion phenomenon can be reduced or prevented by this.

In order similarly to reduce or avoid an internal corrosion phenomenon, there can be a further electrode in the manner of a counter-electrode used for the grounding for cathodic corrosion protection is arranged in the region of the cell supply unit. The internal corrosion phenomenon relates in particular to corrosion effects within the electrolysis device, particularly within the cell supply unit. For example, it may be a titanium electrode, or titanium anode, that may have been coated with a mixed oxide. The thus-formed anode may be arranged in a liquid phase of an oxygen separation vessel of the cell supply unit.

In exemplary embodiments, the substacks are connected to the cell supply unit in parallel in terms of supply. In this way, a good supply with the at least one operating material can be achieved for the substacks. The supply can include feeding and also removing the operating material or substances produced during the electrolysis.

Supply structures, in particular the cell connection conduits, configured in the cell stack or in the electrolysis cells can serve as internal insulation segments. Materials with which for example the water for electrolysis is contacted within the cell stack, excluding in the region of respective active cell areas of the respective electrolysis cells, can satisfy at least one of the following three requirements:
the materials are non-metallic;
metals to which an electric potential is applied are coated with an oxidation-stable layer, such as for example titanium dioxide, a polymer or the like;
uncoated metals are not electrically connected, that is to say are connected essentially electrically potential-free, in particular floating.

It can also be achieved with the invention, inter alia, that the electrodes of the active cell areas of the electrolysis cells can act as anodic counter-electrodes. As a result, for example, minimally more oxygen can be formed at respective anodes of the electrolysis cells and minimally less hydrogen can be produced at respective cathodes of the respective electrolysis cells. However, these changes during the electrolysis do not have a significant impact on the efficiency and safety of the electrolysis device. Rather, the advantage of the invention—that no extraneous ions from metallic elements can be released due to stray currents—predominates.

The features and combinations of features stated hereinabove in the description, as well as the features and combinations of features stated hereinafter in the description of the figures and/or shown in the figures alone, are usable not only in the respectively indicated combination but also in other combinations, without departing from the scope of the invention.

The features and combinations of features stated above in the description and also the features and combinations of features stated in the following description of exemplary embodiments and/or shown in the figures alone are usable not only in the respectively indicated combination but also in other combinations. Thus, embodiments that are not explicitly shown in the figures and elucidated but which emerge and are producible from the elucidated embodiments by separate combinations of features can also be considered to be encompassed or disclosed by the invention. The features, functions and/or effects presented by means of the exemplary embodiments can represent, each taken alone, individual features, functions and/or effects of the invention that are to be considered independently of one another and which each also independently of one another develop the invention. Thus, the exemplary embodiments are intended to also encompass combinations other than those in the elucidated embodiments. Moreover, the embodiments described can also be supplemented by further already-described features, functions and/or effects of the invention.

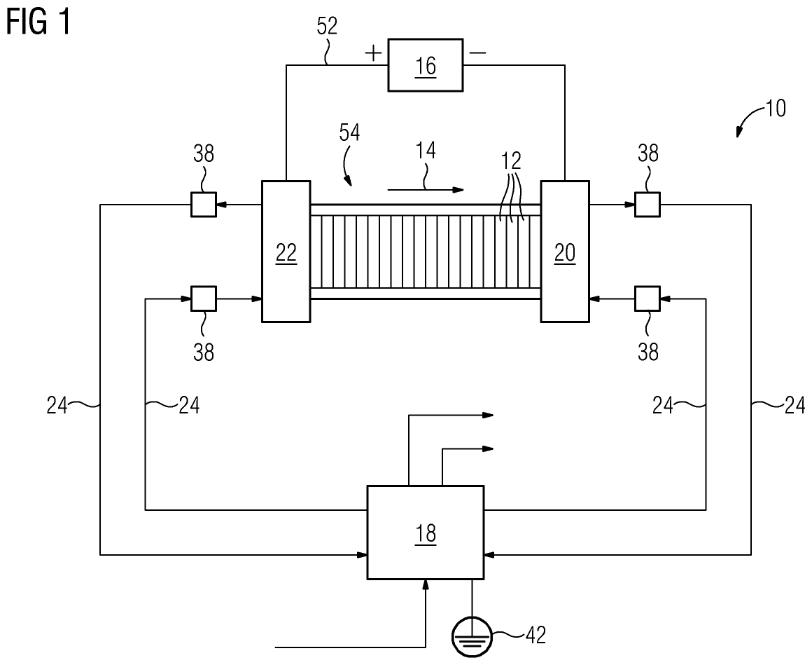

FIG. 1 shows a schematic block diagram of an electrolysis device 10, which has a cell stack 54 having a plurality of electrolysis cells 12 that are arranged successively in a stack direction 14. In the present case, the electrolysis cells 12 serve to electrochemically decompose water into its constituents oxygen and hydrogen. The electrolysis device 10 thus in the present case serves to produce hydrogen and oxygen from water.

The electrolysis cells 12 are in the present case arranged directly adjacent to one another so that respective electrodes of the adjacently arranged electrolysis cells 12 can electrically contact. It is provided here that in each case an anode of a first of the electrolysis cells 12 electrically contacts a cathode of the respectively directly adjacently arranged second electrolysis cell 12. The electrolysis cells 12 are electrically connected in series as a result.

Via an internal supply structure (not illustrated further) of the cell stack 54, the electrolysis cells 12 are firstly supplied with water to be electrolyzed and secondly provided with discharge conduits for the substances produced, hydrogen and oxygen. This supply is configured to be connectable to respectively opposite ends 20, 22 of the cell stack 54.

An electrical energy source 16 is further connected at the ends 20, 22 via an electrical conduit 52 and here provides a suitable electric voltage with a suitable electrical power so that the electrolysis cells 12 can be sufficiently supplied with electrical energy for operation as intended.

The electrolysis device 10 further includes a cell supply unit 18 which serves to supply the electrolysis cells 12 or cell stack 54 with the respective operating materials, which in the present case relates to the feeding of water and the removal of hydrogen and oxygen. The cell supply unit 18 includes a plurality of components that are required for the operation as intended of the electrolysis device 10, such as for example pumps, heat exchangers, separation vessels and/or the like, these not however being illustrated further here. The cell supply unit 18 is connected to the cell stack 54 in terms of supply via supply conduits 24 that are connected to the cell supply unit 18 and the opposite ends 20, 22 of the cell stack 54. The supply conduits 24 thus fluidically couple the supply structure of the cell stack 54. The supply conduits 24 are in the present case formed from a metal such as stainless steel.

In order to avoid a short circuit between the ends 20, 22 of the cell stack 54 through the supply conduits 24 formed from metal, each of the supply conduits 24 has an electrical insulating section 38. This ensures that the ends 20, 22 are electrically insulated from the cell supply unit 18 and hence are also electrically insulated from one another. The supply conduits 24 are located outside of the cell stack 54.

The insulating sections 38 are in the present case essentially formed from an electrical insulation material that may for example be a suitable ceramic material or else a suitable plastic or composite material.

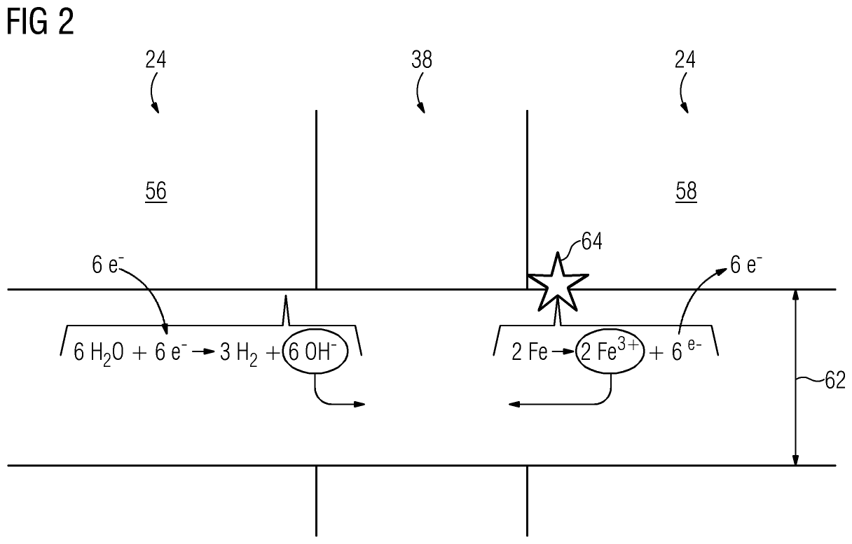

FIG. 2 shows a schematic sectional view of one of the supply conduits 24 from FIG. 1 in the region of the insulating section 38. FIG. 2 illustrates the supply conduit 24 with a first region 58 that faces the end 22 of the cell stack 54, while an opposite second region 56 faces the cell supply unit 18. The regions 56 and 58 are electrically separated from one another by the insulating section 38. This arrangement is fluid-tight as a whole and has an essentially constant internal diameter 62 through which the relevant fluid can be conveyed—this being water in this case.

Due to the electric voltage lying across the electrical insulating section 38, corrosion takes place in a region 64. The reason for this can be considered to be that, in the region of a transition from the region 56 to the electrical insulation section 38, as a result of the water, flowing in the internal diameter 62, accepting electrons from the metal of the wall of the supply conduit 24, negative hydroxide ions are formed that are conveyed to the region 58 by virtue of the electric field and electrochemically react there with the metal of the wall of the supply conduit 24, as illustrated in FIG. 2. As a result, the wall of the supply conduit 24 corrodes in this region 64. This is undesired.

For this kind of corrosion, it should be borne in mind that during operation as intended a DC voltage in a region of several hundred volts can in general lie across the electrical insulating sections 38. This can lead in the region of the electrical insulating section 38 to an excess of electrons in the region 56 and a lack of electrons in the region 58. Due to the magnitude of the electric voltage on the electrical insulating section 38, electrode reactions as previously explained take place from a thermodynamic point of view. While the corrosion effect can be stretched out over time, i.e. kinetically inhibited, by reducing the electric voltage, it cannot be completely suppressed thereby. Even prolonging the insulation segment by means of the electrical insulating section 38 or reducing the internal diameter 62 can only inhibit the corrosion effect in terms of its action, but not avoid it.

In the region 56, the hydrogen formed here may be present dissolved in the water or else in the form of extremely fine bubbles and may be transported away with the water. The amounts produced are in general so small that no disruptive effects result from the hydrogen itself.

However, this does not apply in relation to the hydroxide ions that are present in the water in dissolved form. On account of their negative charge and the direction of the electric field in the region of the electrical insulating section 38, these have a tendency to migrate from the region 56 to the region 58. In this region 58 the metallic material of the supply conduit 24 is then oxidatively decomposed. FIG. 2 illustrates this decomposition for the case in which the supply conduit 24 is formed from stainless steel. However, this effect is not limited to steel, and instead can arise for virtually any other metallic material.

In addition to the release of iron, further metals that may be present in the steel can however also be dissolved. Cations may be formed in this case. On account of their positive charge, the metal cations have the tendency of migrating in the opposite direction to the hydroxide ions. This can result in the occurrence of what is known as rouging from the metal cations, in particular when these are iron ions, and the hydroxide ions. Rouging denotes extremely fine iron-containing particles that can become distributed in the supply conduits 24 and the components of the electrolysis device 10. They can be observed in particular in the supply conduits 24 in which hydrogen is likewise conveyed. If this rouging reaches the oxygen-conveying part of the electrolysis device 10, the rouging can redissolve to form ions.

Cations from the oxygen side can then, inter alia, pass into the electrolysis cells 12 and accumulate there. This process can lead to higher cell voltages and hence lower efficiency of the electrolysis device 10. Mechanisms harmful to the electrolysis cells 12 can also be associated with these cations. For example, hydrogen peroxide formed at the electrodes can on contact with metal ions be converted into radicals that chemically attack a membrane structure of the electrolysis cells 12 and thus can impair the service life of the electrolysis cells 12.

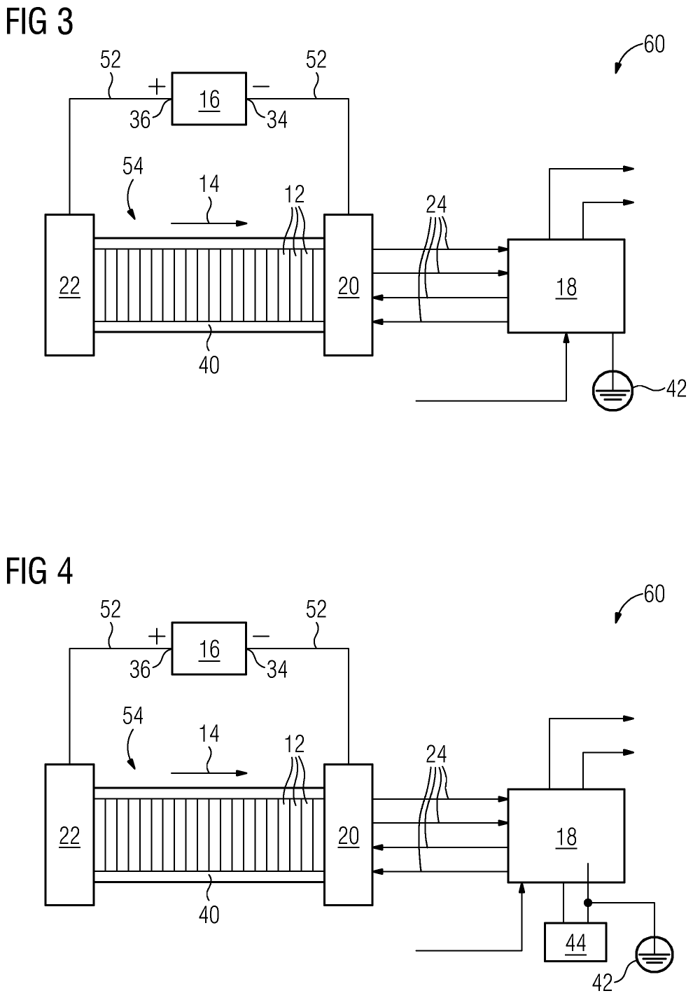

FIG. 3 now shows an electrolysis device 60, with which the aforementioned corrosion effect elucidated on the basis of FIG. 2 can be largely avoided. The construction of the electrolysis device 60 is based on the construction of the electrolysis device 10 as elucidated above on the basis of FIGS. 1 and 2. The following elucidations are based on the elucidations with respect to FIGS. 1 and 2, and reference is therefore additionally made to the statements relating thereto.

As can be seen from FIG. 3, the electrolysis cells 12 are arranged here too in a cell stack 54. The supply conduits 24 are connected exclusively at a first end 20 of the cell stack 54, so that the first end 20 of the cell stack 54 is electrically coupled to the cell supply unit 18. The first end 20 of the cell stack 54 is electrically coupled to a negative electric potential 34 of the electrical energy source 16. The second end 22 of the cell stack 54 is electrically coupled to a positive electric potential 36 of the electrical energy source 16. The statements made with respect to FIGS. 1 and 2 essentially apply for the cell supply unit 18.

The electrolysis cells 12 are here too electrically connected in series so that—from an electrical point of view—a series connection of all electrolysis cells 12 of the cell stack 54 is present again—as in the cell stack 54 according to FIG. 1.

As a result of this construction of the electrolysis device 60, it can be achieved that the cell supply unit 18, considered electrically, has the smallest electric potential of the whole electrolysis device 60. This electric potential is further connected to the negative electric potential 34 of the electrical energy source 16. The electrical energy source 16 additionally provides the positive electric potential 36. Between the negative and the positive electric potential 34, 36, the electrical energy source 16 provides the operating voltage for the operation as intended of the electrolysis device 60.

The cell stack 54 has cell connection conduits 40, also called manifold, for fluidically coupling the electrolysis cells 12 to the supply conduits 24 connected at the first end 20. The cell connection conduits 40 are integrated in the cell stack 54, meaning that there is no need for a corresponding supply structure external to the cell stack.

The cell connection conduits 40 each have a through-opening configured such that a pressure drop on the cell connection conduits 40 enables a uniform operation as intended of the electrolysis cells 12. In the present configuration, the pressure drop is as small as possible such that it can be disregarded for the operation as intended of the electrolysis device 60. As a result, an equal operating pressure can for example be applied to the electrolysis cells 12 in operation as intended. For this purpose the cell connection conduits 40 have through-openings having respective corresponding internal diameters, so that any pressure drop when conveying the respective fluid can largely be disregarded. The respective internal diameter can also vary in a respective one of the cell connection conduits 40 as required. The internal diameter can thus for example be greater at the first end 20 of the cell stack 54 than at the second end 22 of the cell stack 54. In particular, the cell connection conduits 40 can also be integrated at least in sections into the electrolysis cells 12. At the same time, the cell connection conduits 40 can also be provided by the stacking of the electrolysis cells 12.

In this configuration, there is further provision that the through-openings of the cell connection conduits 40 have an inner surface that has been coated with an anodically stable layer. Corrosion effects can be further reduced thereby. For this purpose, the cell connection conduits 40 are in the present case non-metallic.

At the same time, it can also be achieved hereby that the cell connection conduits 40 are electrically insulated. A separate electrical insulation can thus be avoided.

It is further possible by way of the invention for the supply conduits 24—as in this configuration—to be configured without insulating sections. In manufacturing and operational terms, this results in particular advantages, in particular also with respect to safety.

In one embodiment, the cell supply unit 18, as illustrated presently in FIG. 3, is electrically grounded by means of an grounding 42.

FIG. 4 shows a schematic illustration like FIG. 3 of a variant of the electrolysis device 60 according to FIG. 3, with only the differences in relation to the configuration according to FIG. 3 being elucidated hereinafter.

There is provision in FIG. 4 that the grounding 42 is not provided directly at the cell supply unit 18 but rather using a voltage source 44, by means of which an electric potential that is negative with respect to the ground potential is applicable to the cell supply unit 18. For this purpose, the voltage source 44 provides an electric voltage of around−1 V to around−0.8 V. However, this voltage can in principle also be chosen for example within a range from around−2 V to around zero volts.

With an electric voltage set in this way, the corrosion effect, for example in stainless steel, can be even better suppressed against corrosion, even under maritime conditions, for example in offshore applications.

In one embodiment, the counter-electrode for the cathodic corrosion protection is then also arranged in the region of the cell supply unit 18. The electrode provided here for the grounding 42 is formed in the present case by a titanium anode that has been coated with a mixed oxide. The titanium anode with the mixed oxide coating is in the present case arranged, electrically insulated from the cell supply unit 18, in a liquid phase of an oxygen separation vessel (not illustrated further).

The exemplary embodiments overall show that the invention can be used to achieve a reduction in the corrosion by virtue of all supply conduits 24 being connected firstly to the cell supply unit 18 and secondly only to the first end 20 of the cell stack 54.

As a result of the grounding concept of the invention, the release of metal ions can be largely prevented. The electrodes of the active cell areas of the electrolysis cells 12 can therefore act as anodic counter-electrodes for stray currents. Undesired corrosion can thus largely be avoided.

The invention is not restricted to application in the electrolysis of water and can equally also be used in other electrolysis operations that are to be conducted, for example a carbon dioxide electrolysis or the like.

The exemplary embodiments serve exclusively for elucidation of the invention and are not intended to restrict it.

1. An electrolysis device comprising:
a plurality of electrolysis cells that are electrically connected in series and are arranged in a cell stack successively at least partly in a stack direction, wherein the series connection is electrically couplable to an electrical energy source,
a cell supply unit for supplying the electrolysis cells with at least one operating material; and
supply conduits connected to the cell supply unit and to the cell stack, wherein
a material of the supply conduits includes metal, wherein
the supply conduits are connected exclusively at a first end of the cell stack such that the first end of the cell stack is electrically coupled to the cell supply unit, wherein the first end of the cell stack is couplable to a negative electric potential of the electrical energy source.

2. The electrolysis device as claimed in claim 1,
wherein the cell stack has cell connection conduits for fluidically coupling the electrolysis cells to the supply conduits connected at the first end.

3. The electrolysis device as claimed in claim 2,
wherein the cell connection conduits each have a through-opening that is configured such that a pressure drop on the cell connection conduits allows uniform operation as intended of the electrolysis cells.

4. The electrolysis device as claimed in claim 3,
wherein the through-opening has an inner surface that has been coated with an anodically stable layer.

5. The electrolysis device as claimed in claim 2, wherein the cell connection conduits are at least partially non-metallic.

6. The electrolysis device as claimed in claim 2, wherein the cell connection conduits are at least partially electrically insulated.

7. The electrolysis device as claimed in claim 1, wherein the supply conduits are configured at least partially without insulating sections.

8. The electrolysis device as claimed claim 1, wherein the cell supply unit is at least indirectly electrically grounded.

9. The electrolysis device as claimed in claim 8, grounding has at least one of a sacrificial anode and/or a voltage source, by means of which an electric potential that is negative with respect to a ground is applicable to the cell supply unit.

10. The electrolysis device as claimed in claim 9, wherein the voltage source is configured to provide an electric voltage within a range from −2 V to zero volts.
